(19) United States
(12) Patent Application Publication
(10) Pub. No.: US 2016/0156884 A1
(43) Pub. Date: Jun. 2, 2016

(54) INFORMATION EVALUATION APPARATUS, INFORMATION EVALUATION METHOD, AND COMPUTER-READABLE MEDIUM

(71) Applicant: CASIO COMPUTER CO., LTD, Tokyo (JP)

(72) Inventors: Chihiro Toyama, Tokyo (JP); Kazuto Yamamoto, Tokyo (JP); Hirokazu Kanda, Tokyo (JP); Akihito Iwadate, Tokyo (JP); Kazuma Kawahara, Tokyo (JP)

(21) Appl. No.: 14/663,009

(22) Filed: Mar. 19, 2015

(30) Foreign Application Priority Data
Nov. 28, 2014 (JP) 2014-240927

(51) Int. Cl. H04N 9/31; G05B 15/02

(52) U.S. Cl. CPC H04N 9/31; G05B 15/02

(57) ABSTRACT

According to a digital signage apparatus, when an instruction for switching of content output on an image formation unit is provided by a switch button on an operation unit, a control unit evaluates the content based on the switch operation. Specifically, when the switch button is pressed during the output of the content by the image formation unit, the control unit gives a minus evaluation point to the section of the content being output at the time of the switch operation.

### CROSS-REFERENCE TO RELATED APPLICATION

This application is based upon and claims the benefit of priority from the prior Japanese Patent Application No. 2014-240927, filed on Nov. 28, 2014, the entire contents of which are incorporated herein by reference.

### BACKGROUND

1. Technical Field

The present invention relates to an information evaluation apparatus, information evaluation method, and computer-readable medium.

2. Related Art

There is generally known a video output device-equipped apparatus that has a video output device, a reflection member, and a screen that are connected to a video supply device, and reflects output light for projecting content by the reflection member from the video output device, and projects the output light reflected by the reflection member onto a screen formed in a shape adapted to the contour of the content to make a greater impression on viewers as disclosed in JP 2011-150221 A, for example.

There is also a technique for imaging an area where an advertisement display device is installed, recognizing a face image of a person existing in the imaged area, extracting the eye direction of the person from the recognized face image, and evaluating an advertisement according to the eye direction as disclosed in JP 2008-112401 A, for example.

According to the technique disclosed in JP 2008-112401 A, however, a high evaluation mark is obtained once a viewer (user) turns his/her eyes to the content. That is, even if he/she watches the content but thinks it to be uninteresting, his/her thought cannot be incorporated into the evaluation.

An object of the present invention is to allow an evaluation to be performed on information into which a user's thought is incorporated.

### SUMMARY

An information evaluation apparatus including: an output unit configured to output information; and a control unit configured to switch the information output by the output unit according to a user operation and evaluate the information based on the switching.

According to the present invention, it is possible to make an evaluation on information into which a user's thought is incorporated.

### BRIEF DESCRIPTION OF THE DRAWINGS

FIG. 1 is a block diagram illustrating a functional configuration of a digital signage apparatus according to an embodiment;

FIG. 2 is a diagram illustrating an example of data storage in an evaluation point storage unit illustrated in FIG. 1;

FIG. 3 is a diagram illustrating an example of data storage in a summary point storage unit illustrated in FIG. 1;

FIG. 4 is a diagram illustrating a schematic configuration of a screen unit illustrated in FIG. 1;

FIG. 5 is a flowchart of a content output process a executed by a control unit illustrated in FIG. 1;

FIG. 6A is a diagram illustrating ON/OFF of a human sensor, ON/OFF of a switch button, and the type of an occurring trigger during output of content;

FIG. 6B is a diagram illustrating ON/OFF of a human sensor, ON/OFF of a switch button, and the types of occurring triggers during output of content;

FIG. 6C is a diagram illustrating ON/OFF of a human sensor, ON/OFF of a switch button, and the type of an occurring trigger during output of content;

FIG. 6D is a diagram illustrating ON/OFF of a human sensor, ON/OFF of a switch button, and the type of an occurring trigger during output of content;

FIG. 7 is a flowchart of a summation process executed by the control unit illustrated in FIG. 1; and

FIG. 8 is a flowchart of a content output process 13 executed by the control unit illustrated in FIG. 1.

### DETAILED DESCRIPTION

Preferred embodiments of the present invention will be described below in detail with reference to the accompanying drawings. In the following embodiments, a digital signage apparatus 1 is applied as an information evaluation apparatus according to the present invention. The present invention is not limited to the illustrated examples.

### First Embodiment

First, a first embodiment of the present invention will be described.

### [Configuration of the Digital Signage Apparatus 1]

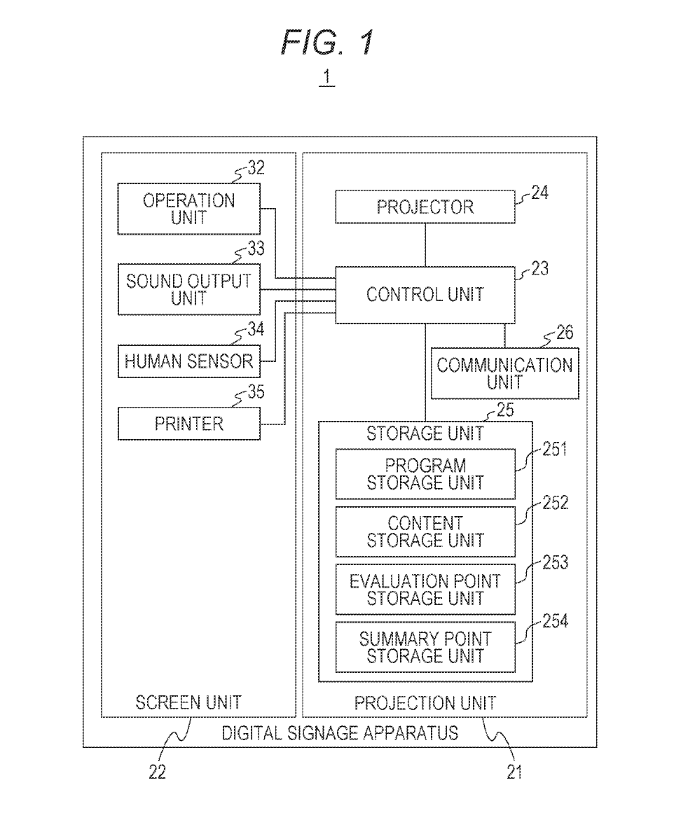

FIG. 1 is a block diagram illustrating a main control configuration of the digital signage apparatus 1. The digital signage apparatus 1 is installed at a store or the like to output content such as product description to users (customers) and evaluate the content according to triggers occurring during the output of the content (content switch operation, approach, departure, and end of the content).

As illustrated in FIG. 1, the digital signage apparatus 1 includes a projection unit 21 that radiates video light for the content, and a screen unit 22 that receives the video light radiated from the projection unit 21 on the back side thereof and projects the same forward.

First, the projection unit 21 will be described.

The projection unit 21 includes a control unit 23, a projector 24, a storage unit 25, and a communication unit 26. The projector 24, the storage unit 25, and the communication unit 26 are connected to the control unit 23 as illustrated in FIG. 1.

The control unit 23 includes a CPU (Central Processing Unit) that executes various programs stored in a program storage unit 251 of the storage unit 25 to perform predetermined arithmetic processing or control the components, and a memory that serves as a working area for execution of the programs (none of them are illustrated in the drawings). The control unit 23 cooperates with the programs stored in the program storage unit 251 of the storage unit 25 to execute a content output process a and a summation process described later. The control unit 23 acts as an evaluation unit, end detection unit, summation unit, and report creation unit.

The projector 24 is a projection device that converts image data output from the control unit 23 into video light and radiates the same onto the screen unit 22. The projector 24 may be a DLP (Digital Light Processing) (registered trademark), for example, that has a DMD (digital micro-mirror device) in which a plurality of micro-mirrors (in the case of XGA, horizontal 1024 pixels ×vertical 768 pixels) is arranged in an array at different angles of inclination and is individually turned on and off for display at high speeds, and reflection light from the micro-mirrors is used to form a light image.

The storage unit 25 is composed of an HDD (Hard Disk Drive), non-volatile semiconductor memory, or the like. The storage unit 25 is provided with the program storage unit 251 as illustrated in FIG. 1. The program storage unit 251 stores a system program to be executed by the control unit 23, processing programs for executing various processes such as the content output process a and the summation process described later, and data and others necessary for execution of these programs.

The storage unit 25 is also provided with a content storage unit 252, an evaluation point storage unit 253, and a summary point storage unit 254.

The content storage unit 252 stores content data for outputting content such as product descriptions to an image formation unit 27 and the like. The content data is composed of moving picture data formed from a plurality of frame images and sound data corresponding to the frame images. The content data is stored in association with IDs (1 to 4 in this example) for identification of the content.

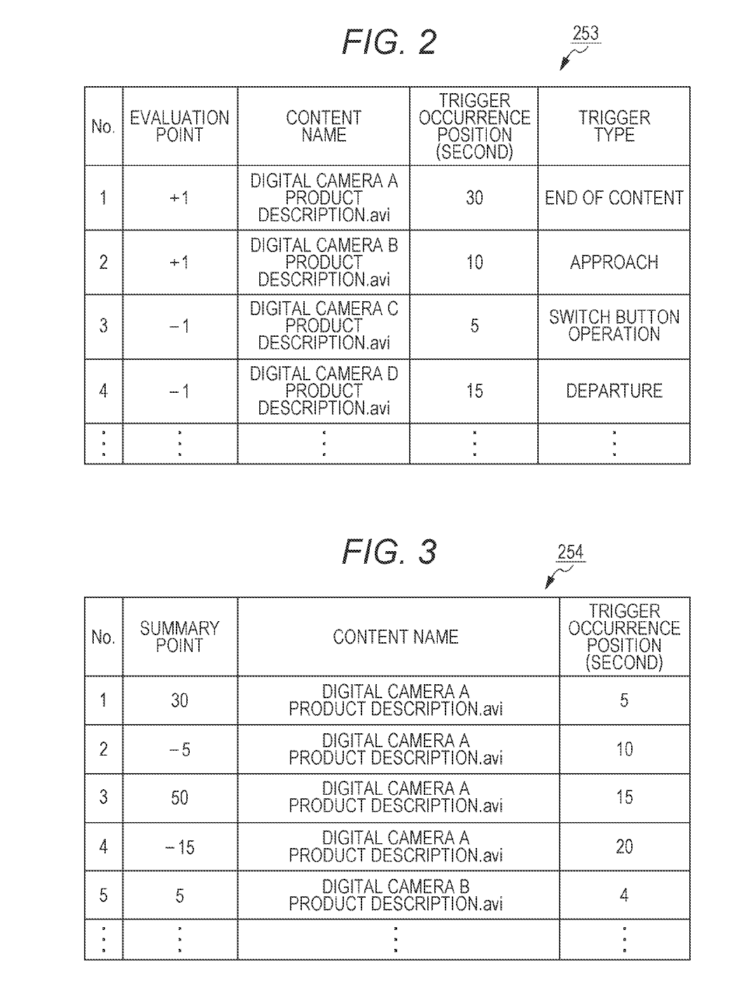

The evaluation point storage unit 253 stores information on triggers occurring in the content output process a at the digital signage apparatus 1 described later, and stores evaluation points given to the occurrence of the triggers. FIG. 2 illustrates an example of data storage in the evaluation point storage unit 253. As illustrated in FIG. 2, the evaluation point storage unit 253 stores data of items “evaluation point,” “content name,” “trigger occurrence position,” and “trigger type.”

The triggers here refer to events that lead to evaluation points (plus (+) or minus (−) evaluation points) indicative of evaluations on output content. In the first embodiment, the four types of triggers include press of a switch button to provide an instruction for switching to another content (switch operation), a person's approach (approach), a person's departure (departure), and detection of end of the content (end of content), but are not limited to them.

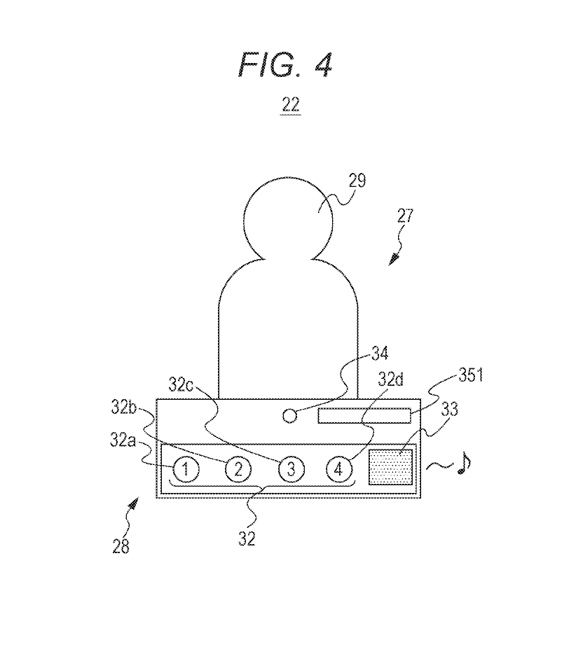

The summary point storage unit 254 stores the results of the summation process described later. FIG. 3 illustrates an example of data storage in the summary point storage unit 254. As illustrated in FIG. 3, the summary point storage unit 254 stores data of items “summary point,” “content name,” and “trigger occurrence position.”

Next, the screen unit 22 will be described.

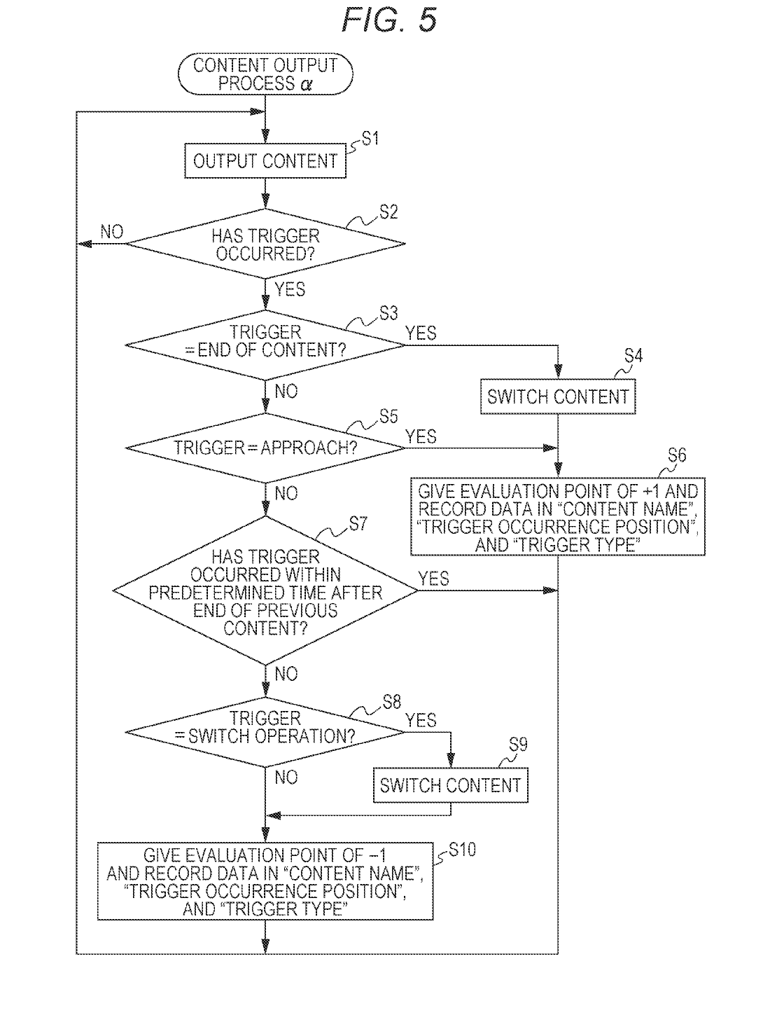

FIG. 4 is a front view illustrating a schematic configuration of the screen unit 22. As illustrated in FIG. 4, the screen unit 22 includes an image formation unit 27 and a base 28 supporting the image formation unit 27.

The image formation unit 27 is a screen, for example, that is configured such that a human-shaped light-permeable plate 29 such as an acrylic plate is arranged approximately orthogonal to the direction of radiation of video light and a film screen for rear projection with a film-shaped Fresnel lens laminated thereon is attached to the light-permeable plate 29. The image formation unit 27 and the projector 24 constitute an output unit.

The base 28 is provided with a button-type operation unit 32, a sound output unit 33 such as a speaker outputting sound, a human sensor 34, and a printer 35.

The operation unit 32 includes various operation buttons such as a first switch button 32a to fourth switch button 32d as a switch unit, and detects a press signal resulting in a press on the operation button and outputs the same to the control unit 23. The first switch button 32a is intended to provide an instruction for a switching to content with ID=1. The second switch button 32b is intended to provide an instruction for a switching to content with ID=2. The third switch button 32c is intended to provide an instruction for a switching to content with ID=3. The fourth switch button 32d is intended to provide an instruction for a switching to content with ID=4.

The human sensor 34 detects the presence of a person within a predetermined range around the digital signage apparatus 1 by infrared rays or ultrasonic waves, and outputs a detection signal to the control unit 23.

The printer 35 is a second output unit that prints a report or the like on a paper according to an instruction from the control unit 23 and outputs the paper from an ejection port 351.

The operation unit 32, the sound output unit 33, the human sensor 34, and the printer 35 are connected to the control unit 23 as illustrated in FIG. 1.

### [Operations of the Digital Signage Apparatus 1]

Next, the operations of the digital signage apparatus 1 will be described.

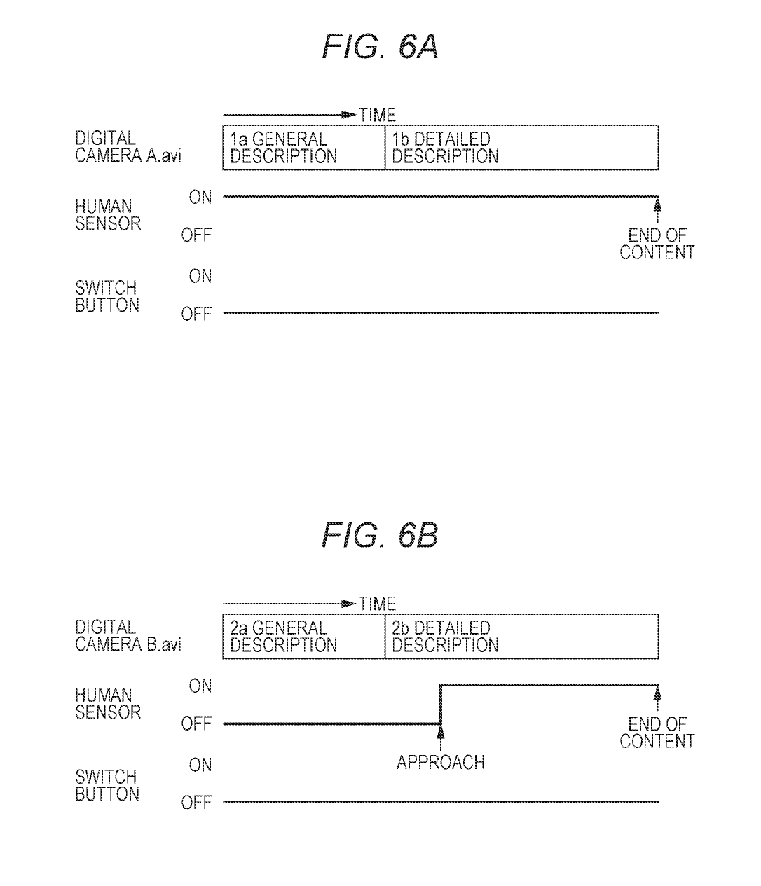

FIG. 5 is a flowchart of the content output process a executed at the digital signage apparatus 1. The content output process a is executed by the control unit 23 in cooperation with the program stored in the program storage unit 251 when the digital signage apparatus 1 is powered on.

In the content output process a, the control unit 23 causes the image formation unit 27 and the sound output unit 33 to output the content (step S1). Specifically, the control unit 23 reads content data of the content to be output from the content storage unit 252, and outputs frame images of the content data in sequence to the projector 24 from which the frame images are projected onto the image formation unit 27. In addition, the control unit 23 outputs sound data of the read content data to the sound output unit 33 from which the sound of the content is output. The content may be images of a person or character describing a product, which are adapted to the shape of the screen of the image formation unit 27, for example.

The content is output in order of IDs associated with the content data. When the last content is output to the end, the output cycle is returned to the first content. If any of the first switch button 32a to the fourth switch button 32d is pressed, switching takes place to the content corresponding to the pressed button. After that, the output cycle is continued from the switched content in order of IDs.

The control unit 23 then determines whether a trigger has occurred (step S2). Specifically, the control unit 23 determines whether any of triggers has occurred, that is, whether any of the first switch button 32a to the fourth switch button 32d has been pressed (switch button operation), a detection signal from the human sensor 34 has been changed from off (no person is detected) to on (a person is detected) (approach), a detection signal from the human sensor 34 has been changed from on to off (departure), or the end of the content data has been detected by the control unit 23 (end of content).

When not determining that any trigger has occurred (step S2: NO), the control unit 23 returns to step S1.

When determining that any trigger has occurred (step S2: YES), the control unit 23 then determines whether the occurring trigger is the end of the content (step S3).

When determining that the occurring trigger is the end of the content (step S3: YES), the control unit 23 switches the output target to the content with the next ID (step S4). The control unit 23 also adds data (records) to the evaluation point storage unit 253 to record “+1” in “evaluation point” (that is, giving an evaluation point of +1) and record the data in “content name,” “trigger occurrence position,” and “trigger type” (step S6). The control unit 23 records the name of the content being output at the occurrence of the trigger in “content name.” The control unit 23 records the output section of the content at the time of occurrence of the trigger, by the time elapsed from the start of output of the content, in “trigger occurrence position.” The control unit 23 records “end of content” as the type of the occurring trigger in “trigger type.” These data recorded in the evaluation point storage unit 253 indicate that the evaluation point indicated in “evaluation point” is given by the occurrence of the trigger indicated in “trigger type” at the section corresponding to “trigger occurrence position” of the content (information) indicated in “content name.”

In this example, occurrence of the end of the content means that the user has watched the whole content (the user has not switched to another content until the end of the content), and thus a plus evaluation point is recorded.

When not determining that the occurring trigger is the end of the content (step S3: NO), the control unit 23 then determines whether the occurring trigger is approach (step S5). When determining that the occurring trigger is approach (step S5: YES), the control unit 23 adds data to the evaluation point storage unit 253 to record +1 in “evaluation point” and record the data “content name,” “trigger occurrence position,” and “trigger type” (step S6).

The occurrence of approach means that a person has approached during output of the content. That is, the content has successfully attracted the person, and thus a plus evaluation point is recorded.

When not determining that the occurring trigger is the end of the content or approach (step S5: NO), the control unit 23 then determines whether the trigger has occurred within a predetermined period of time (within two seconds in this example) after end of the previous content (step S7).

When determining that the trigger has occurred within the predetermined period of time after the end of the previous content (step S7: YES), the control unit 23 returns to step S1 without adding any evaluation point.

When the occurring trigger is not the end of the content or approach, the occurring trigger is switch button operation or departure. In the event of switch button operation, the content before the operation of the switch button has not attracted a person's interest (the content was not interesting for him/her). In the event of departure, a person has departed because the content was not interesting. However, if such a trigger has occurred in a short time (for example, up to three seconds) from the end of the previous content, the currently output content cannot be definitely evaluated to be uninteresting for the user from the length of the time. It is thus conceivable that the user has performed a switch operation or moved around just because it has been a good time for doing so immediately after the end of the previous content. Accordingly, the control unit 23 performs control such that no evaluation point is given even though any of the triggers has occurred within a predetermined period of time (two seconds or less in this example) after the end of the content.

Meanwhile, when no determining that the trigger has occurred within the predetermined period of time after the end of the previous content (step S7: NO), the control unit 23 then determines whether the occurring trigger is a switch operation (step S8).

When determining that the occurring trigger is a switch operation (step S8: YES), the control unit 23 switches the output target to the content corresponding to the pressed switch button (step S9). The control unit 23 then adds data to the evaluation point storage unit 253 to record −1 in “evaluation point” (that is, giving an evaluation point of −1) and record the data in “content name,” “trigger occurrence position,” and “trigger type” (step S10), and then returns to step S1.

When not determining that the occurring trigger is a switch operation (step S8: NO), the control unit 23 adds data to the evaluation point storage unit 253 to record −1 in “evaluation point” (that is, giving an evaluation point of −1) and records the data in “content name,” “trigger occurrence position,” and “trigger type” (step S10), and then returns to step S1.

The control unit 23 repeatedly executes steps S1 to S10 until the digital signage apparatus 1 is powered off.

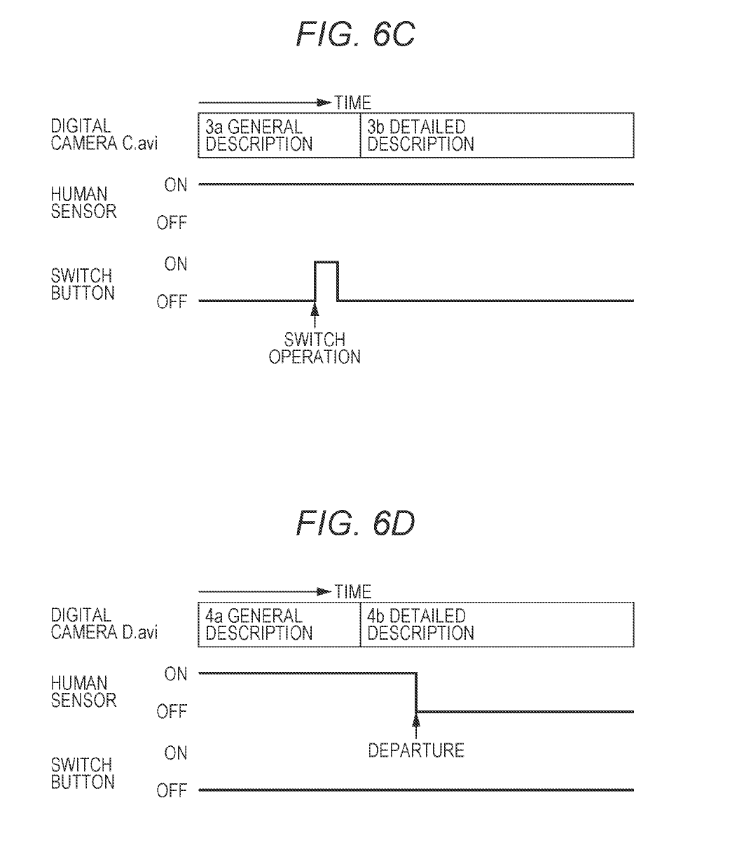

FIGS. 6A to 6D are diagrams illustrating ON/OFF of the human sensor 34, ON/OFF of the switch button, and the type of an occurring trigger(s) during output of content.

With regard to the content “digital camera A product description.avi” in FIG. 6A (described as “digital camera A.avi” in FIG. 6A, which is also applied to FIGS. 6B to 6D), the end of the content is detected while the human sensor 34 remains on and the switch button remains off from the start of output of the content. This content has successfully attracted a person to the end and thus an evaluation point of +1 is given to the end of the file.

With regard to the content “digital camera B product description.avi” in FIG. 6B, the human sensor 34 is off at the start of output of the content, and when the detailed description is started, the human sensor 34 is turned on. At that point of time, the content has successfully attracted a person, and thus an evaluation point of +1 is given to the trigger occurrence position. After that, the end of the file is reached while the human sensor 34 remains on and the switch button remains off, which unit that the content has successfully attracted a person to the end. Accordingly, an evaluation point of +1 is given to the end of the file.

With regard to the content “digital camera C product description.avi” in FIG. 6C, the human sensor 34 is on at the start of output of the content, and then the switch button is turned on in the course of the detailed description to switch to another content. This means that the person thought the content to be uninteresting and departed from the apparatus. Accordingly, an evaluation point of −1 is given to the trigger occurrence position.

With regard to the content “digital camera D product description.avi” in FIG. 6D, the human sensor 34 is on at the start of output of the content and then the human sensor 34 is turned off in the course of the detailed description because the person has departed. This means that the person thought the content to be uninteresting and departed from the apparatus at that point of time. Accordingly, an evaluation point of −1 is given to the trigger occurrence position.

Next, the summation process for summarizing data of evaluation results recorded in the content output process a will be described. The summation process may be executed at the time of power-off of the digital signage apparatus 1 (the end of the day or the like) or may be executed when a predetermined number of data (for example, 100 items of data) are accumulated.

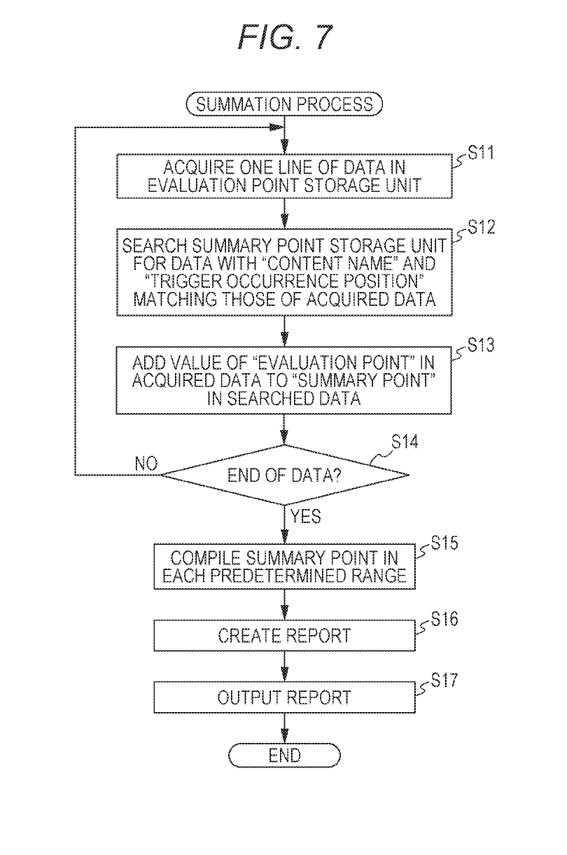

FIG. 7 is a flowchart of the summation process executed at the digital signage apparatus 1. The summation process is executed by the control unit 23 in cooperation with the program stored in the program storage unit 251 when a predetermined timing for summation is reached.

First, the control unit 23 reads and acquires one line of data stored in the evaluation point storage unit 253 (step S11), and searches the summary point storage unit 254 for data with “content name” and “trigger occurrence position” matching those of the acquired data (step S12). The control unit 23 then adds the value of “evaluation point” in the acquired data to the “summary point” in the searched data (step S13). When no matched data is found, the control unit 23 adds records to the summary point storage unit 254 to write the “evaluation point,” “content name,” and “trigger occurrence position” in the data acquired at step S11 to “summary point,” “content name,” and “trigger occurrence position.”

The control unit 23 then determines whether the end of data in the evaluation point storage unit 253 has been reached (step S14).

When not determining that the end of the data in the evaluation point storage unit 253 has been yet reached (step S14: NO), the control unit 23 returns to step S11 to execute steps S11 to S13 on the next data.

When determining that the end of the data in the evaluation point storage unit 253 has been reached (step S14: YES), the control unit 23 compiles the summary points in each of predetermined ranges (step S15). With regard to 30-second content, for example, if plus or minus evaluation points (summary points) are given for individual seconds (for each of 30 seconds), the evaluation results are too fine to analyze. Accordingly, the control unit 23 compiles the summary points on the content by two or three seconds, and adds up the compiled summary points to calculate the summary points in each of the ranges, for example.

The control unit 23 then creates a report based on the compiled summary points (step S16). For example, the control unit 23 picks up a section of the content with the highest summary point and a section of the content with the lowest summary point for creation of the report. For example, the control unit 23 causes the content to be indicated by a time elapsed from the start of output of the content as illustrated in the upper parts of FIGS. 6A to 6D, where the section (time) with the high summary point is marked in green and the section (time) with the low summary point is marked in red, so that the user can easily recognize the good section and bad position of the content. Alternatively, either the section with the highest summary point or the section with the lowest summary point may be picked up for creation of the report.

The control unit 23 then outputs the created report by displaying the same on the image formation unit 27 or printing the same by the printer 35 and ejecting a print from the ejection port 351 (step S17), for example, and then terminates the summation process.

As described above, according to the digital signage apparatus 1 in the first embodiment, when the user presses any of the switch buttons on the operation unit 32 to provide an instruction for switching of the content output on the image formation unit 27 or the like, the control unit 23 evaluates the content based on the switch operation. Specifically, when the user presses the switch button while the image formation unit 27 or the like outputs the content, the control unit 23 gives a minus evaluation point to the section of the content being output at the time of the switch operation.

Therefore, even when the user thinks the content to be uninteresting and performs a switch operation, the user's thought can be incorporated into the evaluation of the content. It is also possible to determine the section of the content at which the user thoughts it to be uninteresting and performed a switch operation, and make a minus evaluation on the section.

The control unit 23 also evaluates the content based on the result of detection by the human sensor 34 during the output of the content by the image formation unit 27. Specifically, when a shift takes place from the state in which no person is detected by the human sensor 34 to the state in which a person is detected by the human sensor 34 during output of the content, the control unit 23 gives a plus evaluation point to the section of the content being output at the time of detection of the person.

Therefore, it is possible to make a plus evaluation on the content having successfully attracted a person. It is also possible to determine the section of the content having successfully attracted a person and make a plus evaluation on the section.

When a shift takes place from the state in which a person is detected by the human sensor 34 to the state in which no person is detected any more by the human sensor 34 during output of the content, the control unit 23 gives a minus evaluation point to the section of the content output when no person was detected any more.

Therefore, it is possible to make a minus evaluation on the content during the output of which a person has departed. It is also possible to determine the section of the content at which a person has departed and make a minus evaluation on the section.

The control unit 23 also evaluates the content according to the result of detection of end of the content output on the image formation unit 27. Specifically, when the end of the output content is detected, the control unit 23 gives a plus evaluation point to the end of the content.

Therefore, it is possible to make a plus evaluation on the content the user has watched to the end.

The control unit 23 also performs control such that, after end of output of the previous content, no minus evaluation point is given until lapse of a predetermined period of time. Therefore, it is possible to prevent that a false evaluation is made on the content according to the user's action unrelated to his/her impression of the content such as when the user has performed a switch operation or departed from there just because it has been a good time for doing so immediately after the end of the previous content.

The control unit 23 also summarizes a plurality of evaluation results of the content for each of the sections by a uniform length of time elapsed from start of output of the content. This makes it possible to clarify the highly evaluated sections and less evaluated sections of the content.

The control unit 23 also performs a summation collectively for each of predetermined ranges, which makes it possible to prevent that the evaluation results are too fine to analyze.

The control unit 23 also creates a report based on the result of the summation and outputs the created report, which makes it possible to provide the user with the result of the summation in report form. Specifically, the control unit 23 creates and outputs the report indicating the section of the content with the highest evaluation point and/or the section of the content with the lowest evaluation point. Accordingly, the user can recognize the section of the content with the highest evaluation point and/or the section of the content with the lowest evaluation point.

### Second Embodiment

A second embodiment according to the present invention will be described below.

In the first embodiment, minus evaluation points are uniformly given to the content that has been switched after lapse of a predetermined period of time since the end of the previous content. In the second embodiment, evaluation results vary depending on whether there is similarity between the pre-switching content output before a switch operation and the post-switching content as described below.

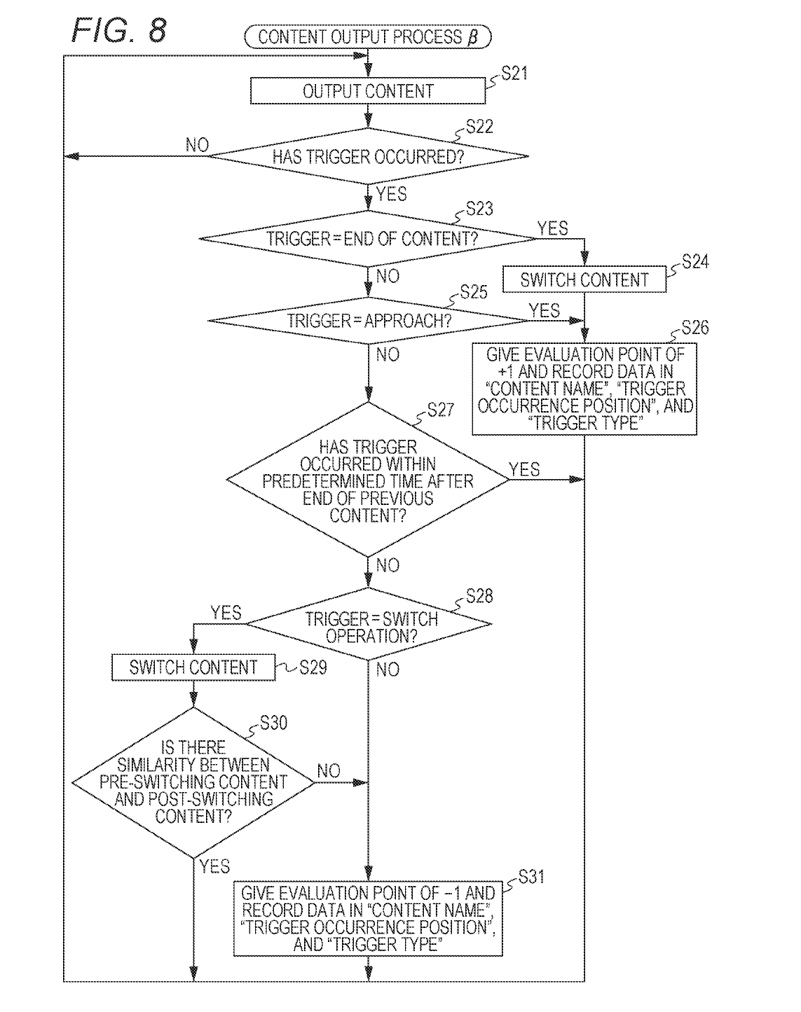

In the second embodiment, the program storage unit 251 of the storage unit 25 stores a program for execution of a content output process β (refer to FIG. 8). A control unit 31 executes the content output process β according to the program. The evaluation point storage unit 253 stores information on triggers occurring in the content output process β and evaluation points given according to the occurrence of the triggers. The storage unit 25 also stores a table that defines in advance whether there is similarity between a plurality of content stored in the content storage unit 252 for use in the content output process β (hereinafter, referred to as content similarity determination table).

The image formation unit 27 is configured to display the description of the post-switching content (the name of a product or the like described in the post-switching content) in association with each of the button numbers of the first switch button 32a to the fourth switch button 32d on the operation unit 32.

Other configurations of the digital signage apparatus 1 are the same as those of the first embodiment and thus the foregoing descriptions of the first embodiment will be incorporated herein. The content output process β will be described below.

FIG. 8 is a flowchart of the content output process β. The content output process β is executed by the control unit 23 in cooperation with the program stored in the program storage unit 251 when the digital signage apparatus 1 is powered on.

In the content output process β, the control unit 23 first executes steps S21 to S29. The steps S21 to S29 are the same as the steps S1 to S9 and thus the foregoing descriptions of the steps S1 to S9 will be incorporated herein.

At step S30, the control unit 23 determines whether there is similarity between the pre-switching content and the post-switching content (step S30). Specifically, the control unit 23 refers to the content similarity determination table stored in the storage unit 25 to determine whether there is similarity between the pre-switching content and the post-switching content.

As in the first embodiment, the content output in the second embodiment is intended to provide users with product description or the like. In the content similarity determination table, a combination of content with similarity in products described is defined as similar content, and a combination of content with dissimilarity in products described is defined as dissimilar content.

When determining that there is similarity between the pre-switching content and the post-switching content (step S30: YES), the control unit 23 returns to step S21 without giving any evaluation point.

When there is similarity between the pre-switching content and the post-switching content, that is, when there is similarity between the products described in the pre-switching content and the post-switching content, it is conceivable that the user did not think the pre-switching content to be uninteresting but had interest in the product described in the post-switching content and performed a switch operation to watch the similar product as well. Accordingly, when determining that there is similarity between the pre-switching content and the post-switching content, the control unit 23 returns to step S21 without giving any evaluation point.

Meanwhile, when not determining that there is similarity between the pre-switching content and the post-switching content (step S30: NO), the control unit 23 adds data to the evaluation point storage unit 253 to record −1 in “evaluation point” (that is, giving an evaluation point of −1) and record the data in “content name,” “trigger occurrence position,” and “trigger type” (step S31), and then returns to step S21.

When there is no similarity between the pre-switching content and the post-switching content, that is, when there is no similarity between the products described in the pre-switching content and the post-switching content, it is conceivable that the user has switched the content because the pre-switching content was uninteresting for him/her, and thus the control unit 23 gives a minus point to the pre-switching content.

When not determining at step S28 that the occurring trigger is a switch operation (step S28: NO), that is, when determining that the occurring trigger is departure, the control unit 23 adds data to the evaluation point storage unit 253 to record −1 in “evaluation point” (that is, giving an evaluation point of −1) and record the data in “content name,” “trigger occurrence position,” and “trigger type” of the pre-switching content (step S31), and then returns to step S21.

The control unit 23 repeatedly executes steps S21 to S31 until the digital signage apparatus 1 is powered off.

For example, when there is no information provided on what content is associated with each of the switch buttons on the operation unit 32 and thus the user cannot understand what content is to be played by pressing each of the switch buttons, or when content is to be switched in sequence by performing a forward button, the user needs to switch among the content to look for a desired one. In this case, for example, when the user watching content has interest in the product described in the content and performs a switch operation because he/she wishes to watch another content describing a similar product, a minus point is wrongly given if the product described in the first content after switching is not similar to the product described in the pre-switching content until the user reaches the desired content describing the similar product.

In such a case, only when a switch operation is performed and the post-switching content is output for a predetermined period of time or more, it may be determined whether there is similarity between the pre-switching content and the post-switching content such that, when there is no similarity between the two, the pre-switching content is evaluated with a minus point.

The data on the evaluation results recorded in the content output process 13 is summarized in the summation process. The summation process is the same as that described above in relation to the first embodiment, and thus the foregoing descriptions will be incorporated herein.

As illustrated above, according to the digital signage apparatus 1 in the second embodiment, when the user presses any of the switch buttons on the operation unit 32 to provide an instruction for switching of the content output on the image formation unit 27 or the like, the control unit 23 evaluates the pre-switching content depending on whether there is similarity between the pre-switching content and the post-switching content. Specifically, when any of the switch buttons is pressed during output of the content on the image formation unit 27 or the like, the control unit 23 determines whether there is similarity between the pre-switching content and the post-switching content. When there is no similarity between the pre-switching content and the post-switching content, the control unit 23 gives a minus point to the section of the content being output at the time of switching of the pre-switching content. When there is similarity between the pre-switching content and the post-switching content, the control unit 23 performs control such that no evaluation point is given to the pre-switching content.

Therefore, when the user had interest in the pre-switching content and switched to another similar content, it is possible to prevent that a minus evaluation point is given to the pre-switching content despite the user's intention.

For example, when the product described in the pre-switching content is similar to the product described in the post-switching content because the user had interest in the pre-switching content and switched to another similar content, it is possible to prevent that a minus evaluation point is given to the pre-switching content despite the user's intention.

The foregoing descriptions of the embodiments are mere preferred examples of the digital signage apparatus according to the present invention, and the present invention is not limited to them.

In the foregoing embodiments, for example, the four triggers for content evaluation, switch operation, approach, departure, and end of content are provided. The types of triggers are not limited to them. For example, only one of them, switch operation, for example, may be used as a trigger, or two or three of them may be used as triggers. Alternatively, other triggers may be added.

In the foregoing embodiments, the human sensor 34 detects a person's approach or departure. The detection unit may be limited to this. For example, the digital signage apparatus 1 may be configured to include a camera configured to shoot its front side such that an image shot by the camera is used to perform face detection and detect a person for determination of his/her approach or departure.

In the foregoing embodiments, the content (information) to be evaluated is moving images. The present invention is not limited to this. For example, the content may be only sound information from a radio. In addition, the content is not necessarily stored in the storage unit 25 but may be TV programs or streaming content.

In the foregoing embodiment, the digital signage apparatus 1 executes the summation process. Alternatively, a plurality of digital signage apparatuses 1 may be configured to connect to a server device via a communication network such as a LAN (Local Area Network) or the Internet such that the server device executes the summation process on the content evaluation results from the plurality of digital signage apparatuses 1.

In the foregoing embodiments, upon detection of end of content, an evaluation point of +1 is given to the content. Alternatively, no evaluation point of +1 may be given when the human sensor 34 remains off during the output of the content.

In the foregoing embodiment, the image formation unit 27 is formed in a human shape. The image formation unit 27 is not limited to this but may be formed in another shape.

In the foregoing embodiments, the present invention is applied to the digital signage apparatus that projects an image from the projector onto the screen to display the image. The present invention is not limited to this but may be applied to information evaluation apparatuses equipped with other display devices such as a liquid-crystal display and plasma display to produce the same advantages as described above.

Besides, detailed configurations and operations of the digital signage apparatus may be modified as appropriate without deviating from the gist of the present invention.

As in the foregoing, some embodiments of the present invention are described. The scope of the present invention is not limited to the foregoing embodiments but includes the scope of the claims and other scopes equivalent to the same.

What is claimed is:

1. An information evaluation apparatus comprising:
an output unit configured to output information; and
a control unit configured to:
switch the information output by the output unit according to a user operation; and
evaluate the information based on the switching.

2. The information evaluation apparatus according to claim 1, wherein, when switching is performed during the output of the information by the output unit, the control unit gives a minus evaluation point to a section of the information being output at the time of the switching.

3. The information evaluation apparatus according to claim 1, wherein, when switching is performed during the output of the information by the output unit, the control unit evaluates pre-switching information depending on whether there is similarity between the pre-switching information and post-switching information.

4. The information evaluation apparatus according to claim 3, wherein, when the post-switching information is output for a predetermined period of time or more after the switching, the control unit evaluates the pre-switching information depending on whether there is similarity between the pre-switching information and the post-switching information.

5. The information evaluation apparatus according to claim 3, wherein, when there is no similarity between the pre-switching information and the post-switching information, the control unit gives a minus evaluation point to a section of the pre-switching information being output at the time of the switching, and when there is similarity between the pre-switching information and the post-switching information, the control unit gives no evaluation point to the pre-switching information.

6. The information evaluation apparatus according to claim 3, wherein
the information is content related to a product description, and
the evaluation unit evaluates the pre-switching information depending on whether there is similarity between a product described in the pre-switching content and a product described in the post-switching content.

7. The information evaluation apparatus according to claim 1, comprising a detection unit configured to detect a person, wherein
the control unit further evaluates the information based on result of detection by the detection unit during the output of the information by the output unit.

8. The information evaluation apparatus according to claim 7, wherein, when a shift takes place from the state in which no person is detected by the detection unit to the state in which a person is detected by the detection unit during the output of the information by the output unit, the control unit gives a plus evaluation point to a section of the information being output at the time of detection of the person.

9. The information evaluation apparatus according to claim 7, wherein, when a shift takes place from the state in which a person is detected by the detection unit to the state in which no person is detected any more by the detection unit during the output of the information by the output unit, the control unit gives a minus evaluation point to a section of the information being output at the time when the person is not detected any more.

10. The information evaluation apparatus according to claim 1, wherein the control unit detects end of the information output by the output unit and evaluates the information based on result of detection of end of the information.

11. The information evaluation apparatus according to claim 10, wherein, when the end of the information is detected, the control unit gives a plus evaluation point to the end of the information.

12. The information evaluation apparatus according to claim 2, wherein the control unit does not give the minus evaluation point to the information until lapse of a predetermined period of time since output of information by the output unit prior to the information.

13. The information evaluation apparatus according to claim 1, comprising a storage unit configured to store a plurality of pieces of information, wherein
the output unit outputs any of the plurality of pieces of information stored in the storage unit.

14. The information evaluation apparatus according to claim 1, wherein the control unit summarizes a plurality of results of evaluation on the information for each of sections by a uniform length of time from start of output of the information.

15. The information evaluation apparatus according to claim 14, wherein the control unit performs the summation collectively for each of predetermined ranges.

16. The information evaluation apparatus according to claim 14, wherein
the control unit creates a report based on result of the summation, and
the output unit outputs the created report.

17. The information evaluation apparatus according to claim 16, wherein
the control unit creates a report indicating a section of the information with the highest evaluation point and a section of the information with the lowest evaluation point from the result of the summation.

18. An information evaluation method, comprising the steps of:
outputting information by output unit;
switching the information output by the output unit according to a user operation; and
evaluating the information based on the switching.

19. A computer-readable medium for use in an information evaluation apparatus including an output unit configured to output information, the medium for causing a computer to execute:
a switching process to switch the information output by the output unit according to a user operation; and
an evaluation process to evaluate the information based on the switching.
